(19) United States
(12) Patent Application Publication
(10) Pub. No.: US 2009/0050229 A1
(43) Pub. Date: Feb. 26, 2009

(54) INSULATING PIPE FIXING SYSTEM

(76) Inventor: Sukyoon Kim, Incheon (KR)

Correspondence Address: IPLA P.A., 3580 WILSHIRE BLVD., 17TH FLOOR, LOS ANGELES, CA, 90010, US

(21) Appl. No.: 12/279,144

(22) PCT Filed: Feb. 12, 2007
(86) PCT No.: PCT/KR07/00747

§ 371 Date: Aug. 12, 2008

(30) Foreign Application Priority Data
Feb. 13, 2006 (KR) 10-2006-0013438

(51) Int. Cl. F16L 9/14

(52) U.S. Cl. 138/149; 138/99

(57) ABSTRACT

The invention relates to a fixing system for an insulating pipe of a dual insulating pipe type used for feeding liquefied LNG or liquid nitrogen, comprising an inner pipe through which the material for feeding passes, insulating material surrounding the inner pipe, and an outer pipe for protecting the insulating material surrounding the inner pipe. The insulating pipe fixing system for inserting and fixing an insulating pipe according to the invention is characterized in that the body of the fixing system is provided with a vacuum area for insulation. Therefore, according to the invention, it is easy to connect and disconnect pipes and this invention can be widely applied to connections of dual insulating pipes. Since the inside of the body is provided with an insulating section, the inner pipe area which is not surrounded by the insulating material can be insulated, so that overall insulation effect can be maximized.

### TECHNICAL FIELD

The invention relates to an insulation pipe connecting and fixing system, and more particularly to an insulating pipe fixing system having a vacuum area inside of the body of the fixing system to maximize insulation effect.

### BACKGROUND ART

Generally, exemplary structures used by connecting pipe type elements are city water and sewage pipes, gas pipes, street lamp pipes, sign boards, indication boards, etc.

Most of the systemes for connecting such structures are made by welding or have a screw structure, which disadvantageously needs in turn a lot of time and labor for assembling and disassembling the system.

As a method to solve the aforementioned problem, a pipe fixing system is disclosed in Korea Patent Application No. 10-2005-0008745 applied by the applicant of the invention. The technical subject of the aforementioned Korea Patent 10-2005-0008745 is to achieve quick pipe (5) assembling or disassembling without any additional work such as welding, etc., wherein the pipe fixing system comprises a body (10) in which the pipe provided with a tapering part (15) is inserted, the tapering part having an overall diameter getting smaller and smaller from the bottom to the top to make a sloping surface; an entry (20) provided inside of an upper insertion groove (22) on top of the body (10) in which the pipe (5) is inserted; a fixing chip (30) for fixing the pipe (5) in the body (10) in a secure way; and a bolt passing through the body (10) and the bolt (40) for controlling the fixing chip (30) to move up or down.

For assembling and disassembling the pipe fixing system, one has to grasp the pipe (5) for fixing to closely insert it in the hollow in the center of the body (10). Then, the pipe (5) contacts the inner diameter of the entry (20) located on top of the body (10) while sliding and being inserted into the body (10). When the pipe (5) reaches a stop (17), the pipe (5) cannot go farther and is thus fixed.

Since the pipe (5), however, is not strong enough to withstand tensile force or other external force only by means of the above fixing, the bolt (40) is coupled to the fixing chip (30) and tightened. Thereafter, the fixing chip (30) rises towards the entry (20), and the fixing chip (30) acts as a wedge between the tapering part (15) and the pipe (5), so that the pipe (5) can be fixed in a secure way.

That is, when the bolt (40) gets tightened while the pipe (5) is inserted and fixed in the body as described above, the bolt (40) turns in the tightened direction, and the fixing chip (30) rises while its peripheral side contacts the inner sloped side of the tapering part (15). In this case, as the fixing chip (30) rises, the peripheral side of the fixing chip (30) rises while sliding across the inner sloped side of the tapering part (15). The inner side of the fixing chip (30) moves into the central direction of the pipe (5) to tighten the outer diameter part of the pipe (5) increasingly strongly.

Then, after fixing the pipe (5) by means of the wedge action of the fixing chip (30) in a secure way, when tightening the bolt (40) stops, the fixing chip (30) and the body (10) are integrated to complete the coupling process.

On the other hand, in order to disassemble the pipe (5), the bolt (40) is loosened in a reverse order to the assemble process to drop the fixing chip (30) in order to eliminate the wedge action by the fixing chip (30) and then to dissemble the pipe (5) easily.

However, the aforementioned configuration has a disadvantage that insulation effect is not enough to use it as a connection and fixing system for an insulating pipe that is a pipe for feeding liquefied LNG or liquid nitrogen,

The structure of the insulating pipe is for a dual heat insulating pipe consisting of an inner pipe through which feeding material generally passes, insulating material surrounding the inner pipe and an outer pipe around the insulating material for protecting the insulating material. The pipe is widely used for feeding commercial or industrial hot water in a local heating system by recycling waste heat generated in a power station, etc., as a pipe requiring insulation in a chemical factory, or for feeding cryogenic liquefied gas (LNG, etc.).

Coupling such conventional insulating pipes is made mainly by welding. In an inevitable case, bayonets are used for flange coupling. The aforementioned configuration is not easy to process, not cost effective and also exhibits weak coupling force.

### DISCLOSURE OF INVENTION

Technical Problem

The invention was conceived to solve aforementioned problems. It is an object of the invention of provide a pipe fixing system for insulation pipes that maximizes insulation effect, can apply strong wedge action without any additional work such as welding and the like, and also can be quickly assembled or disassembled, by forming a vacuum area in a body of the insulating pipe fixing system or coupling an insulating member.

Technical Solution

The invention to achieve the aforementioned object is characterized by an insulating pipe fixing system with which an insulating pipe is inserted and fixed, having a vacuum area in the body therein for insulation.

Here, the invention is also characterized in that the vacuum area being integrated with a suction pipe which passes through the body.

Also, the invention is characterized in that the suction pipe is sealed with a suction pipe cap.

The invention is characterized in that the vacuum area is filled with filling material of polyurethane foam which is inserted through the suction pipe.

Also, the body is provided with a surface tapering from the bottom to the top in which the diameter gets smaller and smaller towards an entry. The top of the body is provided with the entry having a bolt hole and a cut section. On the internal side of the tapering part, a fixing chip is provided having teeth with at least one bolt hole in the center passing upward and downward. There is provided a bolt passing through the bolt hole of the entry and the bolt hole of the fixing chip. A spring washer is inserted and coupled between the upper side of the entry and the bolt head. In the center of the body, a sealing with a stop is provided.

The invention is characterized by am insulating pipe fixing system for inserting and fixing insulation pipes, wherein an insulation member is coupled in the body of the fixing system.

Also, the invention is characterized in that the insulation member is a cylindrical sealing of a vacuum insulation structure. And, the body is provided with a part tapering from the bottom to the top in which the diameter gets smaller and smaller towards the entry. The top of the body is provided with an entry having a bolt hole and a cut section. On the internal side of the tapering part, a fixing chip is provided having teeth with at least one bolt hole in the center passing upward and downward. There is fixed a bolt passing through the bolt hole of the entry and the bolt hole of the fixing chip. A spring washer is inserted and coupled between the upper side of the entry and the bolt head.

Advantageous Effects

With the vacuum pipe fixing system according to the invention and configured as described above, it is possible to maximize heat insulation effect because the inner pipe of the insulating pipe can also be insulated by providing a vacuum area in the body of the insulating pipe fixing system or coupling an insulating member. And additional work such as welding is not required and coupling force can be enhanced because strong wedge action is applied. The method according to the invention is cost-effective because quick pipe assembling or disassembling can be achieved with a simple configuration.

### BRIEF DESCRIPTION OF THE DRAWINGS

FIG. 1 is a cross section of a conventional pipe fixing system.

FIG. 2 is a cross section representing a first embodiment of an insulating pipe fixing system according to the invention.

FIG. 3 is a top view of the insulating pipe fixing system according to the invention.

FIG. 4 is a cross section representing a second embodiment of the insulating pipe fixing system according to the invention.

### MODE FOR THE INVENTION

Now, with reference to the accompanying drawings, the embodiments of the insulating pipe fixing system according to the invention will be described in detail.

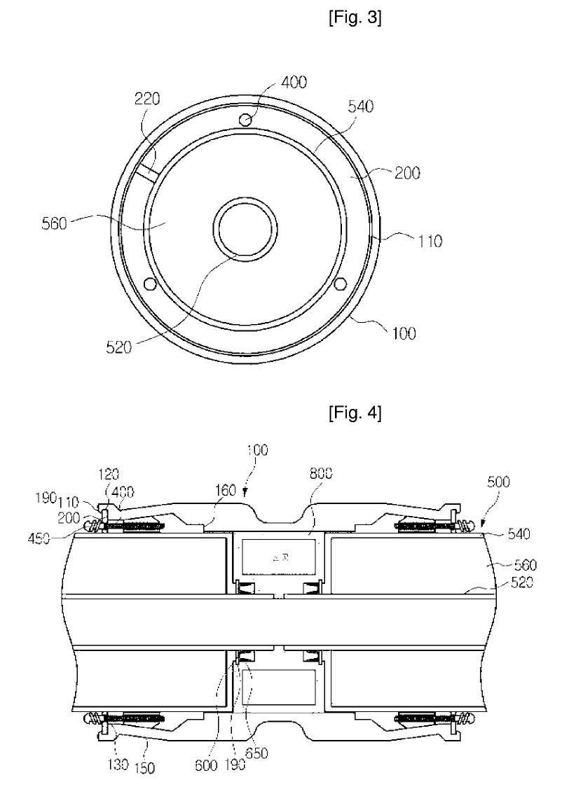

FIG. 2 shows a cross section representing a first embodiment of an insulating pipe fixing system according to the invention. FIG. 3 is a top view of the insulating pipe fixing system according to the invention. FIG. 4 shows a cross section representing a second embodiment of an insulating pipe fixing system according to the invention.

As shown in FIG. 2, the insulating pipe fixing system according to the invention is used to couple and fix an insulating pipe (500) when feeding high-temperature or low-temperature material from one place to another place.

The structure of the insulating pipe (500) is of a dual heat insulation pipe type generally consisting of an inner pipe (520) through which fed material pass, insulating material (560) surrounding the inner pipe (500) and an outer pipe (540) around the insulating material (560) for protecting the insulating material (560).

For connection between the insulating pipes (500), the outside of the inner pipe (520) is not surrounded by the insulating material (560). Therefore, space is made as much as the corresponding area in connecting the pipes. In the space, a vacuum area (700) is provided to achieve excellent insulation effect.

If described in more detail, the insulating pipe fixing system according to the invention consists of a body (100) in which an insulating pipe (500) is inserted, an entry (200) placed in the upper insertion groove (120) on top of the body (100), a fixing chip (300) for fixing the insulating pipe (500) inside of the body (100) in a secure way, a bolt (400) passing through the body (100) and the fixing chip (300) for controlling the fixing chip (300) to move up and down, a spring washer (450) inserted and coupled between the upper side of the entry and the bolt head, a sealing (180) having a stop (170) integrated with the body in the center of the body, and a vacuum area (700) provided on the upper part of the sealing (180). In required, the system may comprise a packing (650) for preventing fluid from leaking in the insulating pipe (500) and a snap ring (600) provided in order to prevent the packing (650) from being released.

Here, on the upper part of the body (100), a hollow is provided in which the insulating pipe (500) is inserted. Around the hollow, there are provided an upper insertion groove (120) and an entry stop (110).

Also, there is provided a guide side (130) in a straight line extending from the upper insertion grove (120) and the entry stop (110) in the lower direction of the body (100). A tapering part (150) is integrated with the guide side, the tapering part (150) having a sloped surface while widening downward from the end of the guide side (130).

The fixing chip (300) is inserted in the body (100), for fixing the outer pipe (540) of the insulating pipe (500) in a secure way. The fixing chip (300) is designed to have a wider lower surface and a narrower top surface, so that the inner surface thereof can rise or fall along the outer pipe (540) of the insulating pipe (500) and the outer surface can rise or fall along the internal sloped side of the tapering part (150). There is provided a bolt hole in the center of the upper surface and the lower surface to allow the bolt (400) to pass therethrough.

There is provided a tooth (320) contacting the insulating pipe (500) and thus applying strong wedge action on the inner surface of the fixing chip (300), so that coupling force with the insulating pipe (500) is further enhanced. The bolt (400) passes through the bolt hole of the entry (200) from the outside of the body (100) and is then coupled with the bolt hole of the fixing chip (300), so that the fixing chip (300) can rise or fall along the outer pipe (540) of the insulating pipe (500).

Here, it is preferred that the spring washer (450) is inserted between the upper side of the entry (200) and the bolt (400) head and the bolt (400) is then coupled. In order to prove the reason, the applicant of the invention produced an insulating pipe fixing system according to the invention to carry out an experiment. The result of the experiment showed that it was possible to obtain about 3 mm of elastic force by inserting the spring washer (450) and about 0.5 mm of elastic force by providing the entry (200), when tensile force was exerted on the insulating pipe (500).

Also, it is preferred to provide three fixing chips (300) for a stable structure.

A sealing (180) having a stop (170) is provided in the center of the inside of the body (100) to stop the insulating pipe (500) from going farther, the pipe (500) coming from both sides. A vacuum area (700) is provided on the outer side of the sealing (180) in order to effectively insulate the connection of the insulation pipe (500). On the sealing (180), a short stop (185) is further provided in order to seal the inner pipe (520) even though the inner pipe (520) of the insulating pipe (500) is not directly connected.

With the vacuum area (700), a suction pipe (750) is integrated which passes through the body (100) and is connected to the outside, so that the pipe (750) can suck up the air in the vacuum area (700) by means of a pump or other suction means then to make a vacuum, to seal the suction pipe (750) with a suction pipe stopper (770) and thus to keep a vacuum.

Furthermore, in the space between the stop (170) and the inner pipe (520) of the insulating pipe (500) and in the recess (160) of the body (100), a packing (650) is provided to prevent fluid in the insulating pipe (500) from leaking, and a snap ring (600) is provided in the space and the insertion hole (190) of the recess (160) to prevent the packing (650) from being released. Here, the packing (650) can, of course, be various in its shape, such as an O-ring, etc.

Although it is not shown, filling material of polyurethane foam type can be used for filling the vacuum area. As an embodiment of the filling material, polyurethane foam can be put through the suction pipe (750) shown in FIG. 2 and the pipe (750) is then sealed with the suction pipe stopper (770) to achieve insulation effect similar to a vacuum.

The polyurethane foam is a polymer compound having an urethane coupling in the molecular structure and is a foam product obtained by mixed reaction of foaming agent, catalyst, surfactant, functional additive, etc. on the basis of polyol and isocyanate. Recently, the foam is widely used as a cold insulation material in ultra-low temperature systemes for LPG or liquefied gases because of its excellent heat insulation capability.

FIG. 3 is a top view of the insulating pipe fixing system according to the invention. As described above, on top of the body (100), there are provided an entry stop (110) and an upper insertion groove (120). The entry (200) is provided in and fixed to the upper insertion groove (120) as shown. The entry stop (110) prevents the entry (200) from being released, but it is designed to slightly overlap the top surface of the entry (200), so that it may separate to the outside of the body (100) when a strong tensile force is exerted to the insulating pipe (500). Because of the structure as described, although the entry (200) is separated to the outside, the insulating pipe (500) is fixed in a more secure way, irrespective of strong tensile force exerted from the outside.

As seen from FIG. 2, since the outer diameter of the entry (200) is larger than the circumference of the entry stop (110) if the entry (200) is of an integrated ring shape, it is impossible to insert the entry (200) in the upper insertion groove (120). Then, a cut section (220) is provided by cutting a part of the entry (200) so that the outer diameter of the entry (200) is made smaller by crossing both ends of the cut section (220) when inserting the entry (200) in the upper insertion groove (120). It is then possible to insert the entry (200) completely in the upper insertion groove (120) by means of self-elastic force of metal.

FIG. 4 is a cross section of a second embodiment of the insulating pipe fixing system according to the invention. In the body (100) of the insulating pipe fixing system, an insulating member, more particularly a cylindrical sealing (800) of a vacuum insulation structure, is coupled instead of the vacuum area (700) provided in the first embodiment shown in FIG. 2.

Here, the cylindrical sealing (800) of the vacuum insulation structure is produced so that the hollow is at a vacuum, and can achieve excellent heat insulation effect because heat conduction or convection does not occur at a vacuum.

Also, it is preferred that such an insulating member as the cylindrical sealing (800) of the vacuum insulation structure is coupled to the inside of the body by means of press-fit. An insulating member like the cylindrical sealing (800) of the vacuum insulation structure can be fit to be exactly fit with the internal surface of the body (100) when the insulating pipe (500) is inserted without movement and fixed in a secure way.

The remaining components shown in the second embodiment of the insulating pipe (500) fixing system according to the invention are identical to the corresponding components shown in the first embodiment of the insulating pipe (500) fixing system according to the invention, and hereinafter will thus not be described in more detail.

However, the packing (650) and the snap ring (600) provided in the recess (160) of the body (100) shown in FIG. 2 are not shown in FIG. 4 which shows the second embodiment of the invention, because another effect is not expected when the insulating member is coupled to the inside of the body (100).

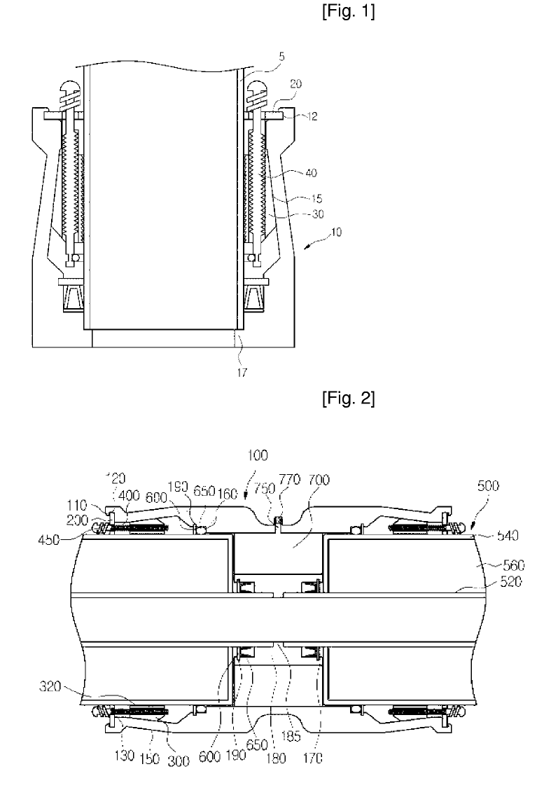

In the insulating pipe fixing system according to the invention, the process of assembling and disassembling the insulating pipe (500) is identical to the process of assembling and disassembling of the pipe (5) disclosed in Korea Patent Application No. 10-2005-0008745, titled Pipe Fixing System shown in FIG. 1 and described above, and will thus not be described in more detail.

It should be noted that the aforementioned embodiments illustrate the most preferred examples of the invention, but the invention is not limited to the embodiments. It will be apparent to those skilled in the art that various modification within the scope of the invention can be made to the invention without departing from technical spirit and scope of the invention.

### Industrial Applicability

The invention will be adopted to connect dual heat insulating pipes consisting of an

inner pipe through which feeding material generally passes, insulating material surrounding the inner pipe and an outer pipe around the insulating material for protecting the insulating material. The invention will be widely used for feeding commercial or industrial hot water in a local heating system by recycling waste heat generated in a power station and will be used to connect pipes requiring insulation in a chemical factory, or for feeding cryogenic liquefied gas (LNG, etc.).

1. An insulating pipe fixing system used for inserting and fixing an insulating pipe, characterized in that a vacuum area for heat insulation is provided in the body of the fixing system.

2. The system as claimed in claim 1, characterized in that a suction pipe passing through the body is integrated with the vacuum area.

3. The system as claimed in claim 2, characterized in that the suction pipe is sealed with a suction pipe tap.

4. The system as claimed in claim 2, characterized in that the vacuum area is filled with filling material of polyurethane foam put through the suction pipe.

5. The system as claimed in claim 1, characterized in that: the body is provided with a part tapering from the bottom to the top in which the diameter gets smaller towards the entry; the top of the body is provided with an entry having a bolt hole and a cut section; on the internal side of the tapering part, a fixing chip is provided having teeth in the center with at least one bolt hole extending upward and downward; there is fixed a bolt passing the bolt hole of the entry and the bolt hole of the fixing chip; a spring washer is inserted between the upper side of the entry and the bolt head and coupled ; and in the center of the body, a sealing with a stop is provided.

6. An insulating pipe fixing system used for inserting and fixing an insulating pipe, characterized in that an insulating member is coupled in the body of the fixing system.

7. The system as claimed in claim 6, characterized in that the insulating member is a cylindrical sealing of a vacuum insulation structure.

8. The system as claimed in claim 6, characterized in that: the body is provided with a part tapering from the bottom to the top in which the diameter gets smaller towards the entry; the top of the body is provided with an entry having a bolt hole and a cut section; on the internal side of the tapering part, a fixing chip is provided having teeth in the center with at least one bolt hole extending upward and downward; there is fixed a bolt passing the bolt hole of the entry and the bolt hole of the fixing chip; and a spring washer is inserted between the upper side of the entry and the bolt head and coupled.
